(19) United States
(12) Patent Application Publication
(10) Pub. No.: US 2026/0194125 A1
(43) Pub. Date: Jul. 9, 2026

(54) SPEED REDUCER

(71) Applicant: Nabtesco Corporation, Tokyo (JP)

(72) Inventor: Kazuyoshi MAKISUMI, Tokyo (JP)

(21) Appl. No.: 19/429,878

(22) Filed: Dec. 22, 2025

(30) Foreign Application Priority Data
Jan. 9, 2025 (JP) 2025-003253

(51) Int. Cl. F16H 1/32

(52) U.S. Cl. CPC F16H 1/321; F16H 2001/323

(57) ABSTRACT

A speed reducer includes: a case having a cylindrical shape; a first flange rotatably supported on an inner circumferential surface of the case via a first bearing; a second flange rotatably supported on the inner circumferential surface of the case via a second bearing; a power transmission pin inserted through a first bolt insertion hole and a second bolt insertion hole; a speed reducing mechanism provided between the first flange and the second flange; a first bearing retainer provided on the first flange, the first bearing retainer retaining the first bearing on an opposite side to the second flange; and a second bearing retainer provided on the second flange, the second bearing retainer retaining the second bearing on an opposite side to the first flange. A hardness of the power transmission pin is higher than those of the first flange and the second flange.

### CROSS-REFERENCE TO RELATED APPLICATIONS

This application is based on and claims the benefit of priority from Japanese Patent Application Serial No. 2025-003253 (filed on January 9, 2025), the contents of which are hereby incorporated by reference in their entirety.

### TECHNICAL FIELD

The present disclosure relates to a speed reducer.

### BACKGROUND

Known types of speed reducers include, for example, an eccentric oscillation speed reducer with high rotational position accuracy and high load resistance. This type of speed reducer includes, for example: a case (frame) having internal teeth (internal pins) provided on its inner circumferential surface; an oscillating gear (external gear) meshed with the internal teeth and configured to oscillatorily rotate; a crankshaft (input rotator) having an eccentric portion rotatably supporting the oscillating gear and being configured to transmit a rotational force to the oscillating gear, power transmission pins (carrier pins) configured to receive a rotational force transmitted from the oscillating gear, and a carrier (output rotator) connected to the power transmission pins.

The crankshaft is rotatably supported by the carrier via rolling bearings. The carrier is rotatably supported by the case via rolling bearings. The carrier has pin insertion holes (through holes) into which the power transmission pins are inserted. The oscillating gear also has pin insertion holes (through holes) into which the power transmission pins are inserted. As the power transmission pins are inserted into these pin insertion holes, the rotation of the oscillating gear can be transmitted to the carrier via the power transmission pins (see, e.g., Japanese Patent Application Publication No. 2017-82993).

Incidentally, it is effective to apply a preload to rolling bearings to increase their moment stiffness. However, the preload applied to the rolling bearings increases the load pre-applied to the rolling bearings, possibly shortening the life of the rolling bearings and reducing drive efficiency.

### SUMMARY

The present disclosure provides a speed reducer that can achieve the desired moment stiffness of rolling bearings, while inhibiting the shortening of the life of the rolling bearings and the reduction of drive efficiency.

A speed reducer according to one aspect of the disclosure comprises: a case having a cylindrical shape; a first flange rotatably supported on an inner circumferential surface of the case via a first rolling bearing, the first flange having a first pin insertion hole extending along a direction of a rotation axis; a second flange rotatably supported on the inner circumferential surface of the case via a second rolling bearing and opposed to the first flange in the direction of the rotation axis, the second flange having a second pin insertion hole extending coaxially with the first pin insertion hole; a power transmission pin inserted through the first pin insertion hole and the second pin insertion hole; a speed reducing mechanism provided between the first flange and the second flange, the speed reducing mechanism being configured to rotate relative to the case, the speed reducing mechanism having a third pin insertion hole receiving the power transmission pin; a first bearing retainer provided on the first flange or an end of the power transmission pin located closer to the first flange, the first bearing retainer retaining the first rolling bearing on an opposite side to the second flange; and a second bearing retainer provided on the second flange or an end of the power transmission pin located closer to the second flange, the second bearing retainer retaining the second rolling bearing on an opposite side to the first flange, wherein the first rolling bearing and the second rolling bearing are preloaded by the first bearing retainer and the second bearing retainer, respectively, and wherein a hardness of the power transmission pin is higher than those of the first flange and the second flange.

With this configuration, when the rotation of the speed reducing mechanism causes the first and second flanges to rotate via the power transmission pin, the tilting of the power transmission pin relative to the rotation axis is negligible if the load on either the first or second flange is small. In this case, the moment stiffness of the first and second rolling bearings does not need to be increased, so the preload applied to the rolling bearings can also be small.

In contrast, if the load on either the first or second flange is large, the force of the power transmission pin to tilt with respect to the rotation axis acts as the speed reducing mechanism tries to rotate. Since the hardness of the power transmission pin is higher than those of the first flange and the second flange, the tiling of the power transmission pin is allowed to some extent. Therefore, the tilting of the power transmission pin causes the flanges to slightly move closer to each other. This movement provides a preload to each of the rolling bearings. As a result, the moment stiffness of the rolling bearings is increased.

Thus, if the load on the speed reducer is small, the preload applied to the rolling bearings can be small. As the load on the speed reducer increases, the preload applied to the rolling bearings can be increased, and the moment stiffness of the rolling bearings can be increased. The speed reducer, therefore, can achieve the desired moment stiffness of the rolling bearings, while inhibiting the shortening of the life of the rolling bearings and the reduction of drive efficiency.

In the above configuration, a magnitude of Young's modulus of the power transmission pin is larger than those of the first flange and the second flange.

In the above configuration, the first flange and the second flange contain at least one of aluminum alloy, magnesium alloy, or resin material, and the power transmission pin contains at least one of iron alloy or titanium alloy.

In the above configuration, the first rolling bearing and the second rolling bearing include at least one of an angular contact ball bearing or a tapered roller bearing.

In the above configuration, the case includes an internal gear having internal teeth, the speed reducing mechanism includes: an oscillating gear having external teeth meshed with the internal teeth; and a crankshaft for causing the oscillating gear to oscillatorily rotate, the oscillating gear rotating eccentrically with respect to the rotation axis, and the oscillating gear has the third pin insertion hole formed therethrough.

The speed reducer according to the present disclosure can achieve the desired moment stiffness of rolling bearings, while inhibiting the shortening of the life of the rolling bearings and the reduction of drive efficiency.

### BRIEF DESCRIPTION OF THE DRAWINGS

FIG. 1 is a sectional view of a speed reducer relating to an embodiment of the present disclosure.

FIG. 2 schematically illustrates power transmission pins tilting, relating to the embodiment of the disclosure.

### DESCRIPTION OF EXAMPLE EMBODIMENTS

The following describes an embodiment of the present disclosure with reference to the drawings.

### Speed Reducer

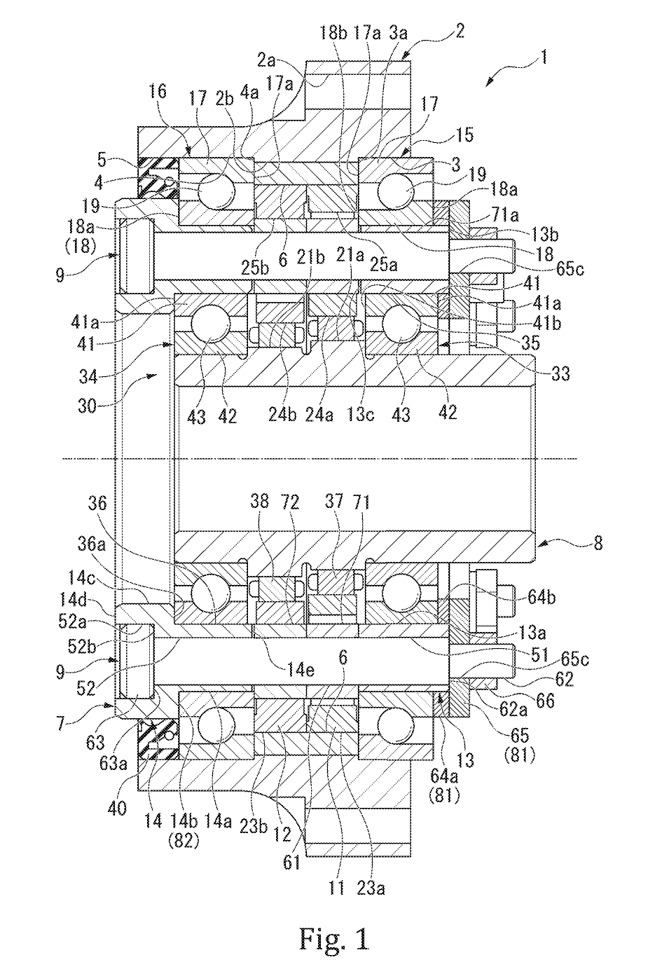

FIG. 1 is a sectional view of a speed reducer 1. As shown in FIG. 1, the speed reducer 1 is an eccentric oscillation speed reducer. The speed reducer 1 includes a cylindrical case 2, and a carrier 7 rotatably supported on the case 2 via two bearings 15 and 16 (first bearing (first rolling bearing) 15 and second bearing (second rolling bearing) 16). In the following description, the terms “axial direction,” “axially” and “axial” refer to the axial direction of the case 2. Similarly, the terms “circumferential direction,” “circumferentially” and “circumferential” refer to the circumferential direction of the case 2. Similarly, the terms “radial direction,” “radially” and “radial” refer to the radial direction of the case 2. In relation with the axial direction, the terms “inside” and “outside” in the axial direction may be used to mean the side closer to the middle of the case in the axial direction and the other side, respectively.

### Case

The case 2 is made of, for example, an iron-based material such as cast iron. Alternatively, the case 2 may be made of, for example, aluminum alloy, magnesium alloy, carbon fiber reinforced plastic (CFRP), or resin containing boron nitride for improved thermal conductivity. In the outer peripheral portion of the case 2, a plurality of bolt holes 2a penetrating the case 2 in the axial direction are arranged at equal intervals in the circumferential direction. Bolts (not shown) are inserted into the bolt holes 2a and tightened into an external device. In this way, the speed reducer 1 can be secured onto the external device.

Bearing housings 3 and 4 (a first bearing housing 3 and a second bearing housing 4) are formed on the inner circumferential surface 2b of the case 2 at the opposing sides of the inner circumferential surface 2b in the axial direction. The bearing housings 3 and 4 have a greater inner diameter than the inner circumferential surface 2b of the case 2 due to steps 3a and 4a. The portion of the inner circumferential surface 2b of the case 2 axially outside the second bearing housing 4 forms a seal housing 5. The seal housing 5 receives a seal 40 fitted thereto. The seal 40 seals between the case 2 and the carrier 7.

The portion of the inner circumferential surface 2b of the case 2 positioned between the two bearing housings 3 and 4 has a plurality of internal tooth pins 6. The internal tooth pins 6 are shaped like a circular column extending in the axial direction. The present embodiment is, however, not limited to such, and the internal tooth pins 6 may be hollow members. The internal tooth pins 6 are arranged at regular intervals in the circumferential direction. The internal tooth pins 6 constitute part of a speed reducing mechanism 30. Specifically, the internal tooth pins 6 serve as internal teeth meshing with oscillating gears 11 and 12, which will be described below.

The first bearing 15 is fitted into the first bearing housing 3 of the case 2. The second bearing 16 is fitted into the second bearing housing 4. Since the first and second bearings 15 and 16 have the same configuration, the following description only focuses on the second bearing 16. The first bearing 15 is not described here. The parts of the first bearing 15 are numbered in the same manner as those of the second bearing 16.

The second bearing 16 is made of high-carbon chromium bearing steel, such as SUJ2. The second bearing 16 is a ball bearing. More specifically, the second bearing 16 is, for example, an angular contact ball bearing. The second bearing 16 has an annular outer ring 17, an annular inner ring 18, which is located radially inward to the outer ring 17, and rolling elements 19 located between the outer ring 17 and the inner ring 18. The outer ring 17 is fitted into the second bearing housing 4. The end face 17a of the outer ring 17 facing inward in the axial direction butts up against the step 4a of the second bearing housing 4. In this way, the second bearing 16 can be rightly positioned relative to the case 2.

### Speed Reducing Mechanism

The speed reducing mechanism 30 includes: the carrier 7; power transmission pins 9 provided in the carrier 7; a crankshaft 8 rotatably supported by the carrier 7 via two bearings 33 and 34; and two oscillating gears 11 and 12 (a first oscillating gear 11 and a second oscillating gear 12) rotatably supported by the crankshaft 8. The rotation axis of the carrier 7 coincides with the rotation axis of the crankshaft 8. These rotation axes coincide with the central axis of the case 2.

The carrier 7 is constituted by a first flange 13 and a second flange 14 facing each other in the axial direction and shaped like a disk. The first and second flanges 13 and 14 are formed of at least one of aluminum alloy, magnesium alloy, or resin material. When the first and second flanges 13 and 14 are formed of aluminum alloy or magnesium alloy, for example, casting is employed. When the first and second flanges 13 and 14 are formed of resin material, for example, injection molding is utilized.

From among the two flanges 13 and 14, the second flange 14 is arranged at the same side as the seal housing 5 of the case 2. The outer circumferential surface of the second flange 14 is fitted to the inner ring 18 of the second bearing 16. The outer circumferential surface of the first flange 13 is fitted to the inner ring 18 of the first bearing 15.

The entire first flange 13 has a uniform thickness in the axial direction. Thus, the outer end face 13b and the inner end face 13c of the first flange 13, which respectively face outward and inward in the axial direction, are flat and parallel to each other. The first flange 13 has a first opening 13a at the center in the radial direction that penetrates through the first flange 13 in the axial direction. A third bearing housing 35 is formed in the first opening 13a.

The first flange 13 has a plurality of first bolt insertion holes (first pin insertion holes) 51 formed in the portion located between the outer circumferential surface of the first flange 13 and the third bearing housing 35. The first bolt insertion holes 51 extend through the first flange 13 in the axial direction. The first bolt insertion holes 51 are equally spaced in the circumferential direction.

The entire second flange 14 has a uniform thickness in the axial direction. Thus, the outer end face 14d and the inner end face 14e of the second flange 14, which respectively face outward and inward in the axial direction, are flat and parallel to each other. The outer circumferential surface of the second flange 14 partly faces the seal housing 5 of the case 2 in the radial direction. The seal 40 is fitted onto this portion of the outer circumferential surface of the second flange 14. This can provide sealing between the case 2 and the second flange 14 of the carrier 7.

The axially inner portion of the outer circumferential surface of the second flange 14 has an outer circumferential bearing housing 14a. The outer circumferential bearing housing 14a has a smaller outer diameter than the second flange 14 due to a step (second bearing retainer) 14b. The inner ring 18 of the second bearing 16 is fitted into the outer circumferential bearing housing 14a. The outer end face 18a of the inner ring 18 facing outward in the axial direction butts up against a step 14b. In this way, the second bearing 16 can be rightly positioned relative to the second flange 14. In other words, the step 14b serves as a second bearing retainer 82 that retains the inner ring 18 of the second bearing 16 on the opposite side to the first flange 13.

The second flange 14 has a second opening 14c at the center in the radial direction that extends through the second flange 14 in the axial direction. The axially inner portion of the inner circumferential surface of the second opening 14c has a fourth bearing housing 36. The fourth bearing housing 36 has a greater inner diameter than the second opening 14c due to a step 36a. The fourth bearing housing 36 is radially next to the outer circumferential bearing housing 14a and to the second bearing housing 4.

The second flange 14 has a plurality of second bolt insertion holes (second pin insertion holes) 52 formed in the portion located between the outer circumferential bearing housing 14a and the fourth bearing housing 36. The second bolt insertion holes 52 extend through the second flange 14 in the axial direction. The second bolt insertion holes 52 are arranged at equal intervals in the circumferential direction. The first and second bolt insertion holes 51 and 52 are coaxially arranged. The inner diameter of the second bolt insertion holes 52 is equal to that of the first bolt insertion holes 51. Each of the second bolt insertion holes 52 has a counterbored portion 52a on the axially outer side. The counterbored portion 52a has a greater inner diameter than the second bolt insertion hole 52 due to a step 52b.

In the carrier 7 configured in the foregoing manner, the third bearing housing 35 of the first flange 13 receives a third bearing 33 fitted thereto. The fourth bearing housing 36 of the second flange 14 receives a fourth bearing 34 fitted thereto. Since the third and fourth bearings 33 and 34 have the same configuration, the following description only focuses on the fourth bearing 34. The third bearing 33 is not described here. The parts of the third bearing 33 are numbered in the same manner as those of the fourth bearing 34.

The fourth bearing 34 is made of high-carbon chromium bearing steel, such as SUJ2. The fourth bearing 34 is a ball bearing. More specifically, the fourth bearing 34 is, for example, a deep groove ball bearing. The fourth bearing 34 has an annular outer ring 41, an annular inner ring 42, which is located radially inward to the outer ring 41, and rolling elements 43 located between the outer ring 41 and the inner ring 42. The outer ring 41 is fitted into the fourth bearing housing 36. The outer end face 41a of the outer ring 41 facing outward in the axial direction butts up against the step 36a of the fourth bearing housing 36. In this way, the fourth bearing 34 can be rightly positioned relative to the second flange 14.

The bolt insertion holes 51 and 52 of the flanges 13 and 14 receive the power transmission pins 9. The power transmission pins 9 are formed of, for example, at least one of iron alloy or titanium alloy. Since the first and second flanges 13 and 14 are formed of at least one of aluminum alloy, magnesium alloy, or resin material, the hardness of the power transmission pins 9 is greater than the hardness of the flanges 13 and 14. More specifically, for example, if the power transmission pins 9 are formed of iron alloy, the Young's modulus of the power transmission pins 9 is about 190 to 210 GPa. For example, if the flanges 13 and 14 are formed of aluminum alloy, the Young's modulus of the flanges 13 and 14 is about 70 to 80 GPa. Thus, the magnitude of Young's modulus of the power transmission pins 9 is larger than those of the flanges 13 and 14.

Each power transmission pin 9 has a columnar shaft 61, an externally threaded portion 62 integrally formed on one end of the shaft 61 in the axial direction, and a head 63 integrally formed on the other end of the shaft 61 in the axial direction. The shaft 61, externally threaded portion 62, and head 63 are arranged coaxially. The outer diameter of the shaft 61 is equal to or slightly smaller than the inner diameter of the first bolt insertion holes 51 and that of the second bolt insertion holes 52.

The externally threaded portion 62 has a smaller outer diameter than the shaft 61 due to a threaded step 62a. The head 63 has a greater outer diameter than the shaft 61 due to a head step 63a. The outer diameter of the head 63 is slightly smaller than the outer diameter of the counterbored portion 52a of the second flange 14.

Configured in the above manner, the power transmission pin 9 is inserted, from the second flange 14 side, into the second bolt insertion hole 52 and then the first bolt insertion hole 51 with the externally threaded portion 62 facing the first flange 13. The head 63 of the power transmission pin 9 is inserted into the counterbored portions 52a of the second bolt insertion hole 52. Since the head step 63a of the power transmission pin 9 butts up against the step 52b of the second bolt insertion hole 52, the power transmission pin 9 can be rightly positioned in the axial direction with respect to the second flange 14.

On the other hand, the externally threaded portion 62 of the power transmission pin 9 protrudes outside the first bolt insertion hole 51 in the axial direction. The externally threaded portion 62 receives a plain washer (first bearing retainer) 65. The externally threaded portion 62 receives a nut 66 which is placed on the plain washer 65 and tightened. An annular first spacer (first bearing retainer) 64a is provided between the inner ring 18 of the first bearing 15 and the plain washer 65. An annular second spacer 64b is provided between the outer ring 41 of the third bearing 33 and the plain washer 65.

Configured in the above manner, when the nut 66 is tightened on the externally threaded portion 62 of power transmission pin 9, the inner ring 18 is slightly pressed inward in the axial direction by the first spacer 64a. Thus, the first spacer 64a and the plain washer 65 serve as a first bearing retainer 81 that retains the inner ring 18 of the first bearing 15 on the opposite side to the second flange 14. The first bearing retainer 81 and the second bearing retainer 82 of the second flange 14 apply a certain level of preload to the first bearing 15 and the second bearing 16 when the nut 66 is tightened.

With the power transmission pin 9 fixed, two bushings 71 and 72 (a first bushing 71 and a second bushing 72) are fitted to the portion of the shaft 61 that is located between the first and second flanges 13 and 14. The bushings 71 and 72 are made of high-carbon chromium bearing steel, such as SUJ2. Thus, the hardness of the bushings 71 and 72 is equal to that of the bearings 15, 16, 33 and 34.

The crankshaft 8 is rotatably supported by the flanges 13 and 14 via the third and fourth bearings 33 and 34. Like the power transmission pins 9, the crankshaft 8 is made of, for example, aluminum alloy. The crankshaft 8 may be made of other possible materials such as stainless steels or various ferrous metals.

The crankshaft 8 is hollow. On the outer circumferential surface of the crankshaft 8, a first eccentric portion 21a and a second eccentric portion 21b are formed next to each other in the axial direction on the portion located between the third and fourth bearings 33 and 34. The first eccentric portion 21a is closer to the first flange 13. The second eccentric portion 21b is closer to the second flange 14. The axes of the eccentric portions 21a and 21b are offset from the rotation axis of the crankshaft 8 (carrier 7). The eccentric portions 21a and 21b are out of phase with each other. For example, the eccentric portions 21a and 21b are out of phase with each other by 180°.

The eccentric portions 21a and 21b are respectively provided with bearings 37 and 38 (a fifth bearing 37 and a sixth bearing 38). The bearings 37 and 38 are needle bearings, for example. The oscillating gears 11 and 12 (the first and second oscillating gears 11 and 12) are rotatably supported on the eccentric portions 21a and 21b via the bearings 37 and 38, respectively. Thus, the oscillating gears 11 and 12 are disposed between the first and second flanges 13 and 14.

The two oscillating gears 11 and 12 are made of, for example, an iron-based material such as chrome molybdenum steel. The two oscillating gears 11 and 12 respectively have crankshaft insertion holes 24a and 24b (a first crankshaft insertion hole 24a, a second crankshaft insertion hole 24b) at their centers in the radial direction. The crankshaft insertion holes 24a and 24b extend through the oscillating gears 11 and 12 in the thickness direction. The bearings 37 and 38 are fitted into the crankshaft insertion holes 24a and 24b, respectively. The outer peripheral portions of the two oscillating gears 11 and 12 have external teeth 23a and 23b, respectively, that mesh with the internal tooth pins 6 provided on the case 2. The number of external teeth 23a and 23b is smaller than that of the internal tooth pins 6 by, for example, one.

The two oscillating gears 11 and 12 have pin insertion holes 25a and 25b (first pin insertion holes (third pin insertion holes) 25a and second pin insertion holes (third pin insertion holes) 25b) that are aligned with the power transmission pins 9. The shafts 61 of the power transmission pins 9 extends through the pin insertion holes 25a and 25b. From among the pin insertion holes 25a and 25b, the first pin insertion holes 25a receive the first bushings 71, which are fitted onto the shafts 61. From among the pin insertion holes 25a and 25b, the second pin insertion holes 25b receive the second bushings 72, which are fitted onto the shafts 61.

As configured in the above-described manner, the eccentric portions 21a and 21b of the crankshaft 8 can cause the oscillating gears 11 and 12 to oscillatorily rotate. The inner diameters of the pin insertion holes 25a and 25b of the oscillating gears 11 and 12 are large enough to allow the oscillatory rotation of the oscillating gears 11 and 12 with the shafts 61 of the power transmission pins 9 and the bushings 71 and 72 being inserted in the pin insertion holes 25a and 25b.

### How Speed Reducer Works

The following now describes how the speed reducer 1 works. Upon rotation of the crankshaft 8, which is caused by a not-shown electric motor, the oscillating gears 11 and 12 rotatably supported by the eccentric portions 21a and 21b are oscillatorily rotated. This causes some of the external teeth 23a and 23b of the oscillating gears 11 and 12 to mesh with the internal tooth pins 6 of the case 2. Since the number of external teeth 23a and 23b is less than that of the internal tooth pins 6 by, for example, one, the meshing positions of the external teeth 23a and 23b with the internal tooth pins 6 (case 2) move sequentially in the circumferential direction while the oscillating gears 11 and 12 are rotated on their own axes. The rotation of the oscillating gears 11 and 12 on their own axes is at a lower speed than the rotation of the crankshaft 8.

The power transmission pins 9 extend through the pin insertion holes 25a and 25b of the oscillating gears 11 and 12. Therefore, as the oscillating gears 11 and 12 are rotated on their own axes, the rotational force in the direction of rotation of the oscillating gears 11 and 12 on their own axes is transmitted to the power transmission pins 9 via the bushings 71 and 72. In other words, the bushings 71 and 72 slide, together with the corresponding oscillating gears 11 and 12.

The power transmission pins 9 are fixedly attached onto the carrier 7 (the first and second flanges 13 and 14). Therefore, the rotational force of the oscillating gears 11 and 12 is transmitted to the carrier 7 via the power transmission pins 9. The carrier 7 is rotatably supported by the case 2 via the first and second bearings 15 and 16. As a result, the carrier 7 is rotated with respect to the case 2. Therefore, the rotation input into the crankshaft 8 is output through the carrier 7 at a reduced speed.

A certain level of preload is applied to the first bearing 15 and the second bearing 16. Therefore, the moment stiffness of the bearings 15 and 16 can be increased compared to the case where no preload is applied. In addition, play of the first and second bearings 15 and 16 in the axial and radial directions can be eliminated, which reduces axial runout occurring when the carrier 7 rotates.

Since the rotation of the oscillating gears 11 and 12 is transmitted to the carrier 7 via the power transmission pins 9, each power transmission pin 9 is pressed in opposite circumferential directions by the oscillating gears 11, 12 and the carrier 7. Therefore, the power transmission pin 9 is subjected to a force to tilt with respect to the axial direction. If the load on the carrier 7 (e.g., the second flange 14) is small, the tilt of the power transmission pin 9 with respect to the axial direction is negligible. In this case, the moment stiffness of the bearings 15 and 16 does not need to be increased. In other words, the preload applied to the bearings 15 and 16 when no load is applied to the carrier 7 is set to a level large enough to ensure a sufficient moment stiffness when the load is small.

In contrast, for example, when the load on the second flange 14 increases, the rotational resistance of the second flange 14 increases, while the force of the power transmission pin 9 to tilt with respect to the axial direction increases as the oscillating gears 11, 12 try to rotate. The hardness of the power transmission pin 9 is higher than the hardness of the carrier 7 (first flange 13, second flange 14). Therefore, the carrier 7 deforms slightly, allowing the power transmission pin 9 to tilt to some extent.

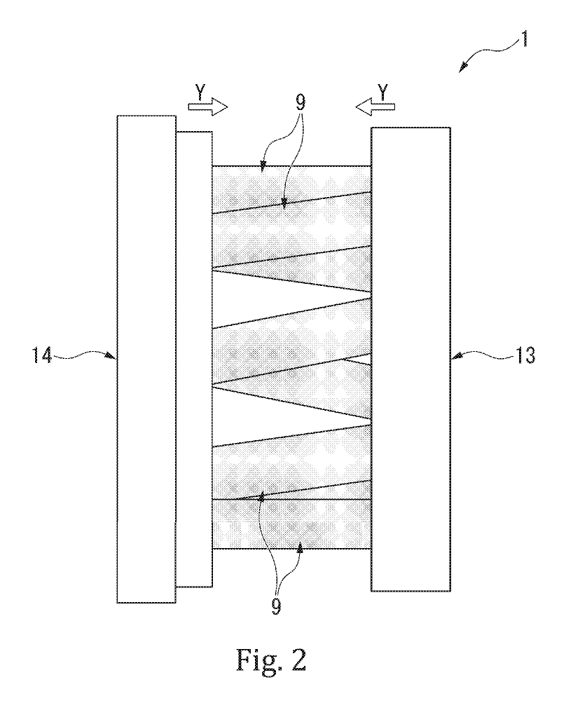

FIG. 2 schematically illustrates power transmission pins 9 tilting. In FIG. 2, the tilting of the power transmission pins 9 is exaggerated. As shown in FIG. 2, the tilting of the power transmission pins 9 causes the flanges 13, 14 to slightly move closer to each other (see the arrows Y in FIG. 2). This movement slightly increases the magnitude of the preload applied to the bearings 15 and 16. This increases the moment stiffness of the bearings 15 and 16.

The speed reducer 1 described above includes the first spacer 64a and the plain washer 65 as the first bearing retainer 81 that retains the inner ring 18 of the first bearing 15 on the opposite side to the second flange 14. The step 14b is formed on the second flange 14 as the second bearing retainer 82 that retains the inner ring 18 of the second bearing 16 on the opposite side to the first flange 13. These bearing retainers 81 and 82 apply a certain level of preload to the first and second bearings 15 and 16. In addition, the hardness of the power transmission pins 9 is higher than the hardness of the carrier 7 (first flange 13, second flange 14). Therefore, when the load on the speed reducer 1 is small, the preload applied to the bearings 15 and 16 can be small. As the load on the speed reducer 1 increases, the preload applied to the bearings 15 and 16 can be increased, and the moment stiffness of the bearings 15 and 16 can be increased. Therefore, the speed reducer 1 can achieve the desired moment stiffness of the bearings 15 and 16, while inhibiting the shortening of the life of the bearings 15 and 16 and the reduction of drive efficiency.

The magnitude of the Young's modulus of the power transmission pins 9 is larger than those of the flanges 13 and 14. This specifically allows the hardness of the power transmission pins 9 to be higher than the hardness of the flanges 13 and 14. In particular, the flanges 13 and 14 are formed of at least one of aluminum alloy, magnesium alloy, or resin material. The power transmission pins 9 are formed of at least one of iron alloy or titanium alloy. This securely allows the hardness of the power transmission pins 9 to be higher than the hardness of the flanges 13 and 14.

The first bearing 15 and the second bearing 16 are angular contact ball bearings. Therefore, preloading the bearings 15 and 16 results in eliminating play of the bearings 15 and 16 in the axial and radial directions and securely increasing the moment stiffness of the same. In the eccentric oscillation speed reducer 1 as described above, it is possible to obtain the desired moment stiffness while at the same time inhibiting shortening of the product life and reduction of drive efficiency.

The present disclosure is not limited to the above embodiment but encompasses various modifications of the above embodiment not departing from the purport of the present disclosure.

For example, the above-described embodiment is directed to the speed reducer 1 including the speed reducing mechanism 30 configured to reduce the rotation of the crankshaft 8 and output the reduced rotation. The embodiment is, however, not limited to such, and the above-described power transmission pins 9 may be applied to various speed reducing mechanisms. The component comparable to the speed reducing mechanism 30 is only required to have pin insertion holes (the pin insertion holes 25a and 25b) for receiving the power transmission pins 9.

The above-described embodiment is directed to the case where the first bearing 15 and the second bearing 16 are angular contact ball bearings. The embodiment, however, is not limited to such, and the bearings 15 and 16 may be any rolling bearings used with a preload applied. For example, the bearings 15 and 16 may be tapered roller bearings. In this way, the bearings 15 and 16 can have an increased moment stiffness.

The above-described embodiment is directed to the case where the step 14b of the second flange 14 serves as the second bearing retainer 82. The disclosure, however, is not limited to such, and the power transmission pins 9 may be provided with a bearing retainer for retaining the inner ring 18 of the second bearing 16. For example, the power transmission pins 9 may be provided with a washer that serves as the second bearing retainer 82.

The above-described embodiment is directed to the case where the first spacer 64a and the plain washer 65 serve as the first bearing retainer 81. The disclosure, however, is not limited to such, and the first flange 13 may be provided with a bearing retainer for retaining the inner ring 18 of the first bearing 15. For example, an outer flange protruding radially outward may be provided on the outer side of the first flange 13 in the axial direction, and this outer flange may serve as the first bearing retainer 81.

In the embodiments disclosed herein, a member formed of multiple components may be integrated into a single component, or conversely, a member formed of a single component may be divided into multiple components. Irrespective of whether or not the components are integrated, they are acceptable as long as they are configured to attain the object of the invention.

What is claimed is:

1. A speed reducer comprising:
a case having a cylindrical shape;
a first flange rotatably supported on an inner circumferential surface of the case via a first rolling bearing, the first flange having a first pin insertion hole extending along a direction of a rotation axis;
a second flange rotatably supported on the inner circumferential surface of the case via a second rolling bearing and opposed to the first flange in the direction of the rotation axis, the second flange having a second pin insertion hole extending coaxially with the first pin insertion hole;
a power transmission pin inserted through the first pin insertion hole and the second pin insertion hole;
a speed reducing mechanism provided between the first flange and the second flange, the speed reducing mechanism being configured to rotate relative to the case, the speed reducing mechanism having a third pin insertion hole receiving the power transmission pin;
a first bearing retainer provided on the first flange or an end of the power transmission pin located closer to the first flange, the first bearing retainer retaining the first rolling bearing on an opposite side to the second flange; and
a second bearing retainer provided on the second flange or an end of the power transmission pin located closer to the second flange, the second bearing retainer retaining the second rolling bearing on an opposite side to the first flange,
wherein the first rolling bearing and the second rolling bearing are preloaded by the first bearing retainer and the second bearing retainer, respectively, and
wherein a hardness of the power transmission pin is higher than those of the first flange and the second flange.

2. The speed reducer of claim 1, wherein a magnitude of Young's modulus of the power transmission pin is larger than those of the first flange and the second flange.

3. The speed reducer of claim 1,
wherein the first flange and the second flange contain at least one of aluminum alloy, magnesium alloy, or resin material, and
wherein the power transmission pin contains at least one of iron alloy or titanium alloy.

4. The speed reducer of claim 1, wherein the first rolling bearing and the second rolling bearing include at least one of an angular contact ball bearing or a tapered roller bearing.

5. The speed reducer of claim 1,
wherein the case includes an internal gear having internal teeth,
wherein the speed reducing mechanism includes:
an oscillating gear having external teeth meshed with the internal teeth; and
a crankshaft for causing the oscillating gear to oscillatorily rotate, the oscillating gear rotating eccentrically with respect to the rotation axis, and
wherein the oscillating gear has the third pin insertion hole formed therethrough.
